(19) United States
(12) Patent Application Publication
(10) Pub. No.: US 2008/0295665 A1
(43) Pub. Date: Dec. 4, 2008

(54) STEEL STRIP SHEARS WITH A HAMMERING DEVICE

(76) Inventor: Hsiu-Man Yu Chen, Tan Tzu Hsiang Taichung (TW)

Correspondence Address: SINORICA, LLC, 528 FALLSGROVE DRIVE, ROCKVILLE, MD, 20850, US

(21) Appl. No.: 11/755,853

(22) Filed: May 31, 2007

(51) Int. Cl. B26D 5/10

(52) U.S. Cl. 83/523; 83/840

(57) ABSTRACT

A steel strip shears with a hammering device consists of a shearing device and a hammering device, which are pivotally connected at a preset location of their front portions, and respectively connected with a commanding handle and a positioning rod at their ends. The hammering device is installed at the rear portion of the positioning rod, able to move back and forth along the positioning rod to strike the rear surface of the positioning rod, so as to quickly squeeze a second blade connected in front of the positioning rod into under a steel strip tied around a packing box, getting ready for shearing.

### BACKGROUND OF THE INVENTION

1. Field of the Invention

This invention relates to a steel strip shears, particularly to one installed with a hammering device.

2. Description of the Prior Art

In order to keep packages or packing boxes packed securely, they are often tied up with steel strips, which have to be cut off usually by a metal shears if the packages or the packing boxes are to be disclosed. As shown in FIG. 1, a conventional steel strip shears includes a shearing device 1 that is composed of two shearing blades 2 pivotally connected together. A shearing mouth 3 is formed in the front portion of the shearing device 1 for cutting therein. Each end of the shearing blades 2 is connected with a commanding handle 4 employed to be held to activate the shearing blades 2 to cut off steel strips 6 tied up around a packing box 5. However, the steel strips 6 are always tied up around the package 5 so tightly that it is uneasy to push one of the shearing blades 2 into under the steel strip 6 so as to carry out shearing. Therefore, a hammer 7 is often used to strike the end of one of the commanding handles 4 to protrude the shearing blade 2 under the steel strip 6 for shearing. That is, the hammer 7 has to be carried with the shearing device 1 any time, posing an inconvenience in practice.

### SUMMARY OF THE INVENTION

The objective of this invention is to offer a steel strip shears with a hammering device.

The main characteristics of the invention are a shearing device and a hammering device. The shearing device is provided with a first shearing blade and a second shearing blade, which are pivotally connected at a preset location of their front portion, and respectively connected with a commanding handle and a positioning rod at their end. The hammering device is installed at the rear portion of the positioning rod, provided with a struck block and a striking sleeve. The struck block is set in a preset location of the positioning rod, provided with a struck surface formed at its end surface. The striking sleeve is engaged with the rear portion of the positioning rod and the struck block, able to move back and forth along the positioning rod to strike the struck block, so as to quickly squeeze a second shearing blade connected in front of the positioning rod into under a steel strip tied around a packing box, getting ready for shearing.

### BRIEF DESCRIPTION OF DRAWINGS

This invention is better understood by referring to the accompanying drawings, wherein:

FIG. 1 is a perspective view of a conventional steel strip shears;

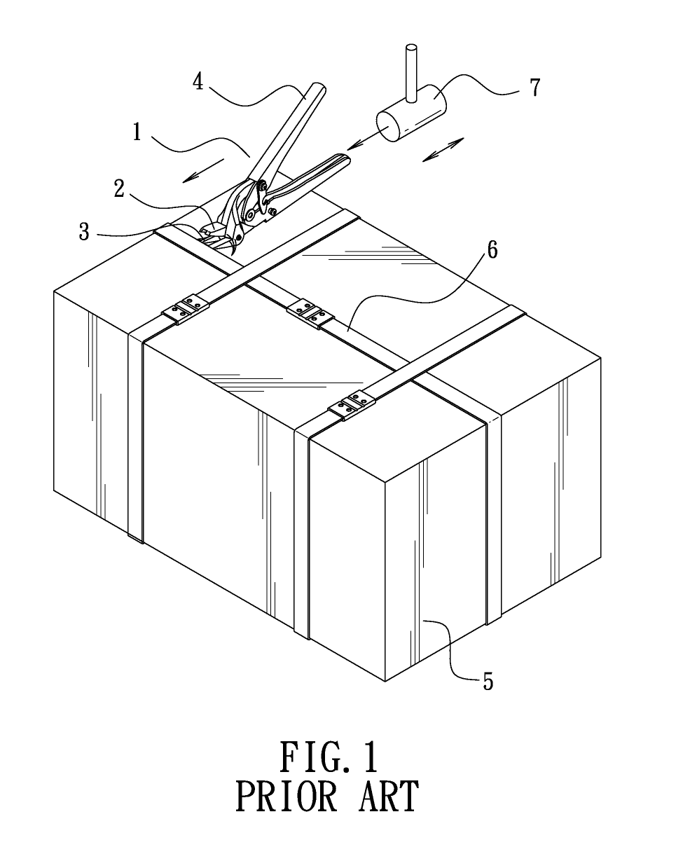

FIG. 2 is a perspective view of a preferred embodiment of a steel strip shears with a hammering device in the present invention;

FIG. 3 is a partial cross-sectional view of the preferred embodiment of a steel strip shears with a hammering device in the present invention, showing a striking sleeve of the hammering device being ultimately pulled off the end of a positioning rod;

FIG. 4 is a partial cross-sectional view of the preferred embodiment of a steel strip shears with a hammering device in the present invention, showing a struck block being hit by a striking block of the striking sleeve of the hammering device; and

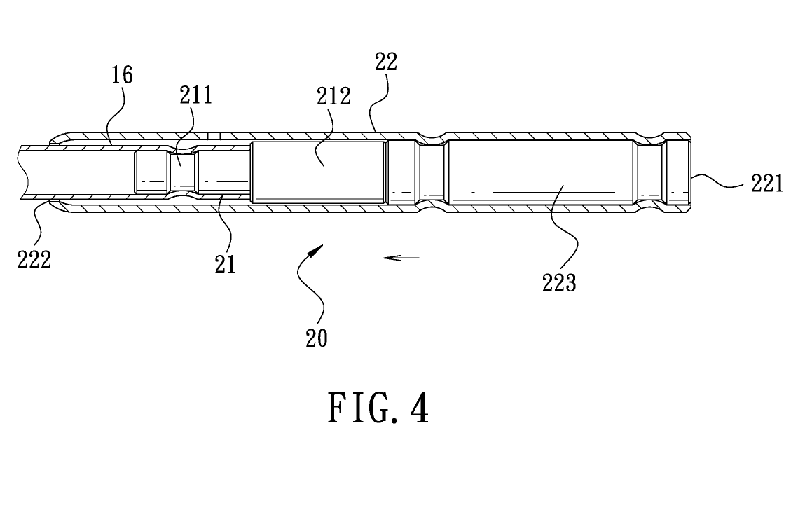

FIG. 5 is a perspective view of the preferred embodiment of a steel strip shears with a hammering device in the present invention, showing it being operated.

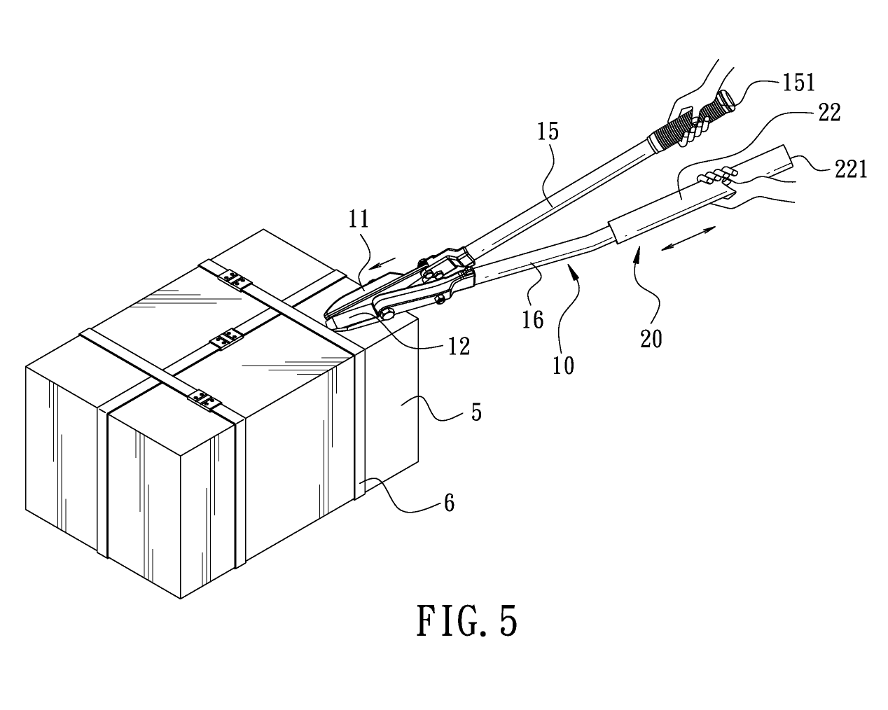

### DETAILED DESCRIPTION OF THE PREFERRED EMBODIMENT

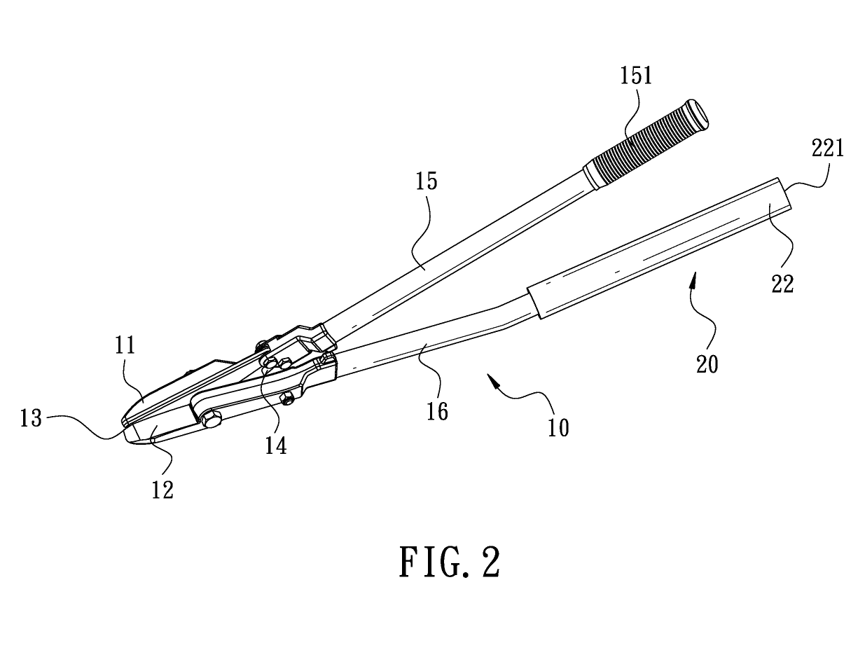

As shown in FIG. 2, a preferred embodiment of a steel strip shears with a hammering device in the present invention is composed of a shearing device 10 and a hammering device 20.

The shearing device 10 includes a first shearing blade 11 and a second shearing blade 12. The first shearing blade 11 and the second shearing blade 12 are pivotally connected at a preset location of their front portions, so as to form a shearing mouth 13 at the front of the shearing device 10. The first shearing blade 11 is connected pivotally at one side of the second shearing blade 12 by means of a pivot 14 positioned at the end of the first shearing blade 11. The first shearing blade 11 is connected with a commanding handle 15 at its end, which is provided with a grip 151 wrapped around its rear end portion for a hand to grab. The second shearing blade 12 is connected with a positioning rod 16 at its end, which is a round tube having its rear portion bent upward. The first shearing blade 11 is driven by the commanding handle 15 to pivotally move up and down against the second shearing blade 12 by means of the pivot 14.

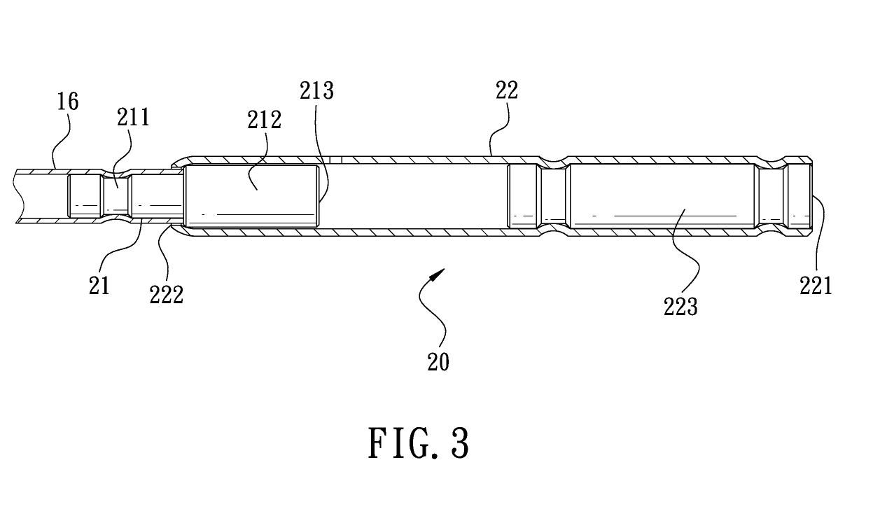

The hammering device 20, with reference to FIG. 3, is installed at the bent rear portion of the positioning rod 16, provided with a struck block 21 and a striking sleeve 22. The struck block 21 is shaped cylindrical and made of metal thermally treated, provided with a connecting member 211 inserted in the rear portion of the positioning rod 16, and a struck member 212 axially jointed behind the connecting member 211 with a diameter slightly larger than that of the positioning rod 16 so as to keep the struck member 212 blocked at the end of the positioning rod 16. The outer end surface of the struck member 212 is shaped as a struck surface 213. The striking sleeve 22 is a round tube fitted with the positioning rod 16 and the struck block 21, provided with a sealed surface 221 formed at its outer end and an annular restricting member 222 tapered at its front with a diameter smaller than that of the struck member 212 so that it is to be blocked around the edge of the struck member 212 while moving the striking sleeve 22 off the positioning rod 16, preventing the struck sleeve 22 from falling off the positioning rod 16. Installed inside the rear portion of the striking sleeve 22 is a weight 223 that is as well made of metal thermally treated.

As shown in FIGS. 3˜5, when the invention is to be used, the front end of the second blade 12 is first put slightly under the steel strip 6 tied around the packing box 5 and then, hold the striking sleeve 22 and move it back and forth along the positioning rod 16, forcing the weight 223 to hit the struck block 21, so as to move the second shearing blade 12 further between the packing box 5 and the steel strip 6. Next, the first shearing blade 11 can be driven to cut the steel strip 6 by the commanding handle 15. It should be noted that the rear portion of the positioning rod 16 is bent upward, enabling the striking sleeve 22 to move down along the positioning rod 16 to hit on the struck surface 213 with an advanced collision.

The invention has the following advantages as can be seen from the foresaid description.

1. By means of the hammering device 20, the second shearing blade 12 can quickly be pushed through under the steel strip 6 tied around the packing box 5 to carry out shearing.

2. The striking sleeve 22 added with the heavy weight 223 can hit effectively on the struck block 21 set inside the positioning rod 16.

While the preferred embodiment of the invention has been described above, it will be recognized and understood that various modifications may be made therein and the appended claims are intended to cover all such modifications that may fall within the spirit and scope of the invention.

What is claimed is:

1. A steel strip shears with a hammering device comprising:
a shearing device including a first shearing blade and a second shearing blade that are pivotally connected at a preset location of their front portions so as to form a shearing mouth at a front of said shearing device, said first shearing blade connected with a commanding handle at its end, said second shearing blade connected with a positioning rod at its end;
a hammering device installed at a rear portion of said positioning rod and provided with a struck block and striking sleeve, said struck block inserted in a rear end portion of said positioning rod to form a struck surface at its end, said striking sleeve engaged with an rear portion of said positioning rod and said struck block, said striking sleeve further provided with a sealed surface formed at its outer end and a restricting member formed at its front.

2. The steel strip shears with a hammering device as claimed in claim 1, wherein said striking sleeve is provided with a weight installed in its rear portion.

3. The steel strip shears with a hammering device as claimed in claim 1, wherein said positioning rod has its rear portion bent upward slightly.

4. The steel strip shears with a hammering device as claimed in claim 1, wherein said struck block is provided with a connecting member and a struck member, said connecting member fixed in the rear portion of said positioning rod, said struck member connected to an end of said connecting member and having a diameter larger than that of said positioning rod so as to be blocked outside the end of said positioning rod.

5. The steel strip shears with a hammering device as claimed in claim 1, wherein said restricting member is formed through tapering a front portion of said striking sleeve, having a diameter smaller than that of said struck member.
